(19) United States
(12) Patent Application Publication
(10) Pub. No.: US 2024/0320325 A1
(43) Pub. Date: Sep. 26, 2024

(54) ANALYSIS SUPPORT METHOD AND ANALYSIS SUPPORT DEVICE

(71) Applicant: Panasonic Automotive Systems Co., Ltd., Kanagawa (JP)

(72) Inventors: Takayoshi ITO, Osaka (JP); Shoichiro SEKIYA, Osaka (JP); Yuishi TORISAKI, Osaka (JP); Kaoru YOKOTA, Hyogo (JP)

(73) Assignee: Panasonic Automotive Systems Co., Ltd., Kanagawa (JP)

(21) Appl. No.: 18/733,447

(22) Filed: Jun. 4, 2024

Related U.S. Application Data
(63) Continuation of application No. PCT/JP2022/030663, filed on Aug. 10, 2022.

(30) Foreign Application Priority Data
Dec. 15, 2021 (JP) 2021-203570

(51) Int. Cl. G06F 21/55

(52) U.S. Cl. CPC G06F 21/552; G06F 2221/034

(57) ABSTRACT

An analysis support method is performed by an analysis support device that supports an analysis of an attack scenario in an event that has occurred in a monitored object, and the analysis is performed based on raw data related to the event. The analysis support method includes: obtaining the raw data by communicating with the monitored object or communicating with a database that stores the raw data obtained from the monitored object; and outputting a previous analysis result for previously obtained raw data that is similar to the raw data obtained.

### CROSS REFERENCE TO RELATED APPLICATIONS

This is a continuation application of PCT International Application No. PCT/JP2022/030663 filed on Aug. 10, 2022, designating the United States of America, which is based on and claims priority of Japanese Patent Application No. 2021-203570 filed on Dec. 15, 2021.

### FIELD

The present disclosure relates to an analysis support method, an analysis support device, and a program.

### BACKGROUND

Conventionally, an analysis support method and the like is known which supports an analysis related to an object to be monitored (monitored object). As an example of the analysis support method and the like, Patent Literature (PTL) 1 discloses a method including: registering an event to be analyzed; collecting raw data associated with the registered event; analyzing the raw data and acquiring location information of an intended network location associated with an attack in the registered event; determining whether the registered event is valid based on the acquired location information; and generating an exceptional processing message of the registered event and transmitting the generated exceptional processing message to a security management server when the registered event is determined not to be valid.

### CITATION LIST

### Patent Literature

PTL 1: Japanese Unexamined Patent Application Publication No. 2019-536158

### SUMMARY

However, the analysis support method according to PTL 1 can be improved upon.

In view of this, the present disclosure provides an analysis support method capable of improving upon the above related art.

An analysis support method according to one aspect of the present disclosure is an analysis support method performed by an analysis support device that supports an analysis of an attack scenario in an event that has occurred in a monitored object. The analysis is performed based on raw data related to the event. The analysis support method includes: obtaining the raw with data by communicating the monitored object or communicating with a database that stores the raw data obtained from the monitored object; and outputting a previous analysis result for previously obtained raw data that is similar to the raw data obtained.

The general and specific aspects described above may be realized using a system, a method, an integrated circuit, a computer program, or a computer-readable recording medium such as a CD-ROM, or in any combination of systems, methods, integrated circuits, computer programs, and recording media. The recording medium may be a non-transitory recording medium.

An analysis support method and the like according to one aspect of the present disclosure is capable of improving upon the above related art.

Additional benefits and advantages according to one aspect of the present disclosure will become apparent from the description and drawings. The benefits and/or advantages may be individually obtained by various embodiments and features of the description and drawings, which need not all be provided in order to obtain one or more of the features.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating a functional configuration of an analysis support device and the like according to Embodiment 1.

FIG. 2 is a flowchart illustrating an example of an operation of the analysis support device in FIG. 1.

FIG. 3 is a table illustrating event information obtained by the analysis support device in FIG. 1.

FIG. 4 is a table illustrating a group of event information stored in the analysis support device in FIG. 1.

FIG. 5 is a flowchart illustrating an example of an operation included in step S3 of FIG. 2.

FIG. 6 is a flowchart illustrating another example of the operation included in step S3 of FIG. 2.

FIG. 7 is a table illustrating another example of the operation included in step S3 of FIG. 2.

FIG. 8 is a flowchart illustrating another example of the operation of the analysis support device in FIG. 1.

FIG. 9 is a table illustrating one or more groups.

FIG. 10 is a flowchart illustrating another example of the operation included in step S3 of FIG. 2.

FIG. 11 is a flowchart illustrating another example of the operation included in step S3 of FIG. 2.

FIG. 12 is a table illustrating an example of a display on the analysis support device in FIG. 1.

FIG. 13 is a table illustrating another example of the display on the analysis support device in FIG. 1.

FIG. 14 is a block diagram illustrating a functional configuration of an analysis support device and the like according to Embodiment 2.

FIG. 15 is a flowchart illustrating an example of an operation of the analysis support device in FIG. 14.

### DESCRIPTION OF EMBODIMENTS

### Underlying Knowledge Forming Basis of the Present Disclosure

The inventors of the present disclosure have found that the following problem arises in relation to the analysis support method disclosed in PTL 1 described in the “Background” section.

In a conventional method such as the analysis support method disclosed in PTL 1, when an event has occurred in a monitored object, whether an analysis is necessary is determined for each event, so that the number of analyses performed is reduced per event. However, conventionally, when analyzing an event that has occurred in a monitored object, an analysis is performed on each of one or more items of raw data related to the event. Hence, it is not possible to reduce the number of analyses performed per raw data, leading to an increase in the number of analyses performed on the one or more items of raw data related to the event.

In view of the above, the present disclosure provides an analysis support method and the like capable of preventing an increase in the number of analyses performed on one or more items of raw data related to an event that has occurred in a monitored object.

Specifically, in order to solve the problem described above, an analysis support method according to one aspect of the present disclosure is an analysis support method performed by an analysis support device that supports an analysis of an attack scenario in an event that has occurred in a monitored object. The analysis is performed based on raw data related to the event. The analysis support method includes: obtaining the raw data by communicating with the monitored object or communicating with a database that stores the raw data obtained from the monitored object; and outputting a previous analysis result for previously obtained raw data that is similar to the raw data obtained.

With this, it is possible to output the previous analysis result for the previously obtained raw data similar to the obtained raw data. This allows the analysis result for the raw data similar to the obtained raw data to be output without analyzing the obtained raw data, and reduces an increase in the number of analyses performed on one or more items of raw data related to the event that has occurred in the monitored object.

Moreover, in order to solve the problem described above, an analysis support method according to one aspect of the present disclosure is an analysis support method performed by an analysis support device that supports an analysis of an attack scenario in an event that has occurred in a monitored object. The analysis is performed based on raw data related to the event. The analysis support method includes: obtaining the raw data and a determination result that is obtained by a security information and event management device based on the raw data; and outputting a previous analysis result for previously obtained raw data and a previously obtained determination result that are similar to the raw data obtained and the determination result obtained.

With this, it is possible to output the previous analysis result for the previously obtained raw data and determination result that are similar to the obtained raw data and determination result. This allows the analysis result for the raw data and determination result similar to the obtained raw data and determination result to be output without analyzing the obtained raw data and determination result, and reduces an increase in the number of analyses performed on one or more items of raw data related to the event that has occurred in the monitored object.

Moreover, it may be that the analysis support method includes: collating the raw data obtained with each of one or more items of previously obtained raw data; determining whether the one or more items of previously obtained raw data include similar raw data that is similar to the raw data obtained; and when the one or more items of previously obtained raw data include the similar raw data, outputting a previous analysis result for the similar raw data.

With this, when raw data similar to the obtained raw data is available, it is possible to output the analysis result for the similar raw data. This allows the analysis result for the raw data similar to the obtained raw data to be output without analyzing the obtained raw data, and reduces an increase in the number of analyses performed on one or more items of raw data related to the event that has occurred in the monitored object.

Moreover, it may be that the raw data includes a plurality of entries, and the analysis support method includes: collating a content of each of the plurality of entries included in the raw data obtained with a content of each of a plurality of entries included in each of the one or more items of previously obtained raw data; and when the one or more items of previously obtained raw data include raw data that includes a plurality of entries that are identical in content to the plurality of entries included in the raw data obtained, determining that the one or more items of previously obtained raw data include the similar raw data.

With this, it is possible to output the analysis result for raw data including a plurality of entries with the same contents as the contents of the plurality of entries included in the obtained raw data among the one or more items of previously obtained raw data. This allows an analysis result with a higher accuracy to be output.

With this, it may be that the raw data includes a plurality of entries, and the analysis support method includes: collating a content of each of the plurality of entries included in the raw data obtained with a content of each of the plurality of entries included in each of the one or more items of previously obtained raw data; calculating a score for each of the one or more items of previously obtained raw data, by (i) adding a point when the content of each of the plurality of entries included in the raw data obtained is identical to a content of a corresponding one of the plurality of entries included in each of the one or more items of previously obtained raw data, and (ii) adding no point or deducting a point when the content of each of the plurality of entries included in the raw data obtained is not identical to the content of the corresponding one of the plurality of entries included in each of the one or more items of previously obtained raw data; and when the one or more items of previously obtained raw data include raw data with a calculated score that is greater than or equal to a predetermined threshold value, determining that the one or more items of previously obtained raw data include the similar raw data.

With this, it is possible to output the analysis result for raw data with a calculated score that is greater than or equal to the predetermined threshold value among the one or more items of previously obtained raw data. This allows an analysis result with a higher accuracy to be output.

Moreover, it may be that the raw data includes a plurality of entries, the one or more items of previously obtained raw data are classified into one or more groups according to each of the plurality of entries, and the analysis support method includes: when the one or more groups include a group related to a content identical to a content of each of the plurality of entries included in the raw data obtained, classifying the raw data obtained into the group; and when the one or more groups include no group related to the content identical to the content of each of the plurality of entries included in the raw data obtained, classifying the raw data obtained into a new group.

This makes it easy to recognize, for example, whether raw data similar to the obtained raw data has been previously obtained.

Moreover, it may be that the analysis support method includes: collating the content of each of the plurality of entries included in the raw data obtained with a content of each of the plurality of entries related to each of the one or more groups; and when the one or more groups include a group related to a content identical to the content of each of the plurality of entries included in the raw data obtained, determining that the one or more items of previously obtained raw data include raw data similar to the raw data obtained.

With this, it is possible to output the analysis result for the raw data belonging to a group related to the same contents as the contents of the plurality of entries included in the obtained raw data among the one or more groups. This allows raw data similar to the obtained raw data to be efficiently found, and an analysis result with a higher accuracy to be output.

Moreover, it may be that the analysis support method includes: collating the content of each of the plurality of entries included in the raw data obtained with a content of each of the plurality of entries related to each of the one or more groups; calculating a score for each of the one or more groups, by (i) adding a point when the content of each of the plurality of entries included in the raw data obtained is identical to a content of a corresponding one of the plurality of entries related to each of the one or more groups, and (ii) adding no point or deducting a point when the content of each of the plurality of entries included in the raw data obtained is not identical to the content of the corresponding one of the plurality of entries related to each of the one or more groups; and when the one or more groups include a group with a calculated score that is greater than or equal to a predetermined threshold value, determining that the one or more items of previously obtained raw data include raw data similar to the raw data obtained.

With this, it is possible to output the analysis result for the raw data belonging to the group with a calculated score that is greater than or equal to the predetermined threshold value among the one or more groups. This allows raw data similar to the obtained raw data to be efficiently found, and an analysis result with a higher accuracy to be output.

Moreover, it may be that the analysis support method includes: collating the raw data obtained with each of the one or more items of previously obtained raw data; determining whether the one or more items of previously obtained raw data include similar raw data that is similar to the raw data obtained; when the one or more items of previously obtained raw data include the similar raw data, determining whether a user is authorized to view a previous analysis result for the similar raw data; and when the user is authorized to view the previous analysis result for the similar raw data, outputting the previous analysis result for the similar raw data.

With this, when the user is authorized to view the analysis result for the raw data, it is possible to output the analysis result for the raw data. This prevents unauthorized persons from viewing the analysis result.

In order to solve the problem described above, an analysis support device according to one aspect of the present disclosure is an analysis support device that supports an analysis of an attack scenario in an event that has occurred in a monitored object. The analysis is performed based on raw data related to the event. The analysis support device includes: a processor; and a memory connected to the processor, wherein the processor executes, using the memory: obtaining the raw data by communicating with the monitored object or communicating with a database that stores the raw data obtained from the monitored object; and outputting a previous analysis result for previously obtained raw data that is similar to the raw data obtained.

With this, the same operations and advantageous effects as those of the analysis support method described above are obtained.

In order to solve the problem described above, a program according to one aspect of the present disclosure is a program for causing a computer to execute the analysis support method.

With this, the same operations and advantageous effects as those of the analysis support method described above are obtained.

Hereinafter, embodiments will be specifically described with reference to the drawings.

Each of the following embodiments describes a general or specific example. The numerical values, shapes, materials, structural elements, the arrangement and connection of the structural elements, steps, order of the steps, etc., shown in the following embodiments are mere examples, and therefore do not limit the present disclosure. Among the structural elements in the following embodiments, those not recited in any of the independent claims are described as optional structural elements.

Note that the figures are schematic illustrations and are not necessarily precise depictions. In the figures, the structural elements that are essentially the same share like reference signs.

### Embodiment 1

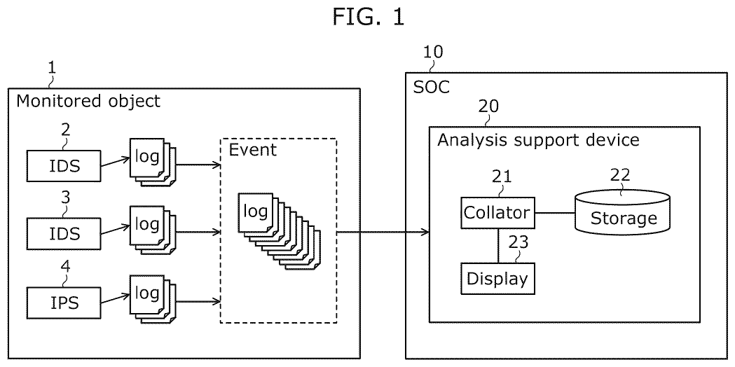

FIG. 1 is a block diagram illustrating a functional configuration of analysis support device 20 and the like according to Embodiment 1. With reference to FIG. 1, the functional configuration of analysis support device 20 and the like will be described.

As illustrated in FIG. 1, security operation center (SOC) 10 is a security operation center that monitors monitored object 1.

For example, monitored object 1 is a vehicle, a mobile terminal, a building, or a vessel. Monitored object 1 includes intrusion detection system (IDS) 2, intrusion detection system (IDS) 3, and intrusion prevention system (IPS) 4. Each of IDS 2, IDS 3, and IPS 4 detects an event that has occurred in monitored object 1. Examples of the event that has occurred in monitored object 1 include an unauthorized intrusion into monitored object 1 and an attack on monitored object 1. For example, each of IDS 2, IDS 3, and IPS 4 monitors communications between monitored object 1 and an external device and the like. When detecting an event that has occurred in monitored object 1, each of IDS 2, IDS 3, and IPS 4 outputs raw data related to the event. For example, the raw data related to the event is a log of the event. For example, monitored object 1 transmits, to SOC 10, a plurality of items of raw data related to a single event that has occurred in monitored object 1.

SOC 10 includes analysis support device 20. SOC 10 analyzes an event that has occurred in monitored object 1. Analysis support device 20 does not have to be included in SOC 10.

Analysis support device 20 is a device that supports an analysis of the event that has occurred in monitored object 1. For example, analysis support device 20 supports the analysis of an attack scenario in an event that has occurred in monitored object 1. The analysis is performed based on raw data related to the event. Conventionally, an event that has occurred in monitored object 1 is analyzed by an analyst with security expertise, for example, as follows. First, the analyst checks one or more items of raw data related to the event one by one, determines whether or not there was an attack, an attack method, the vulnerability, and the like, and then integrates the result of the determination for each item of raw data to identify an attack scenario and the like for the event. When one or more items of raw data related to the event that has occurred in monitored object 1 include raw data similar to the previously obtained raw data, analysis support device 20 outputs the previous analysis result for the previously obtained raw data. This eliminates the need to analyze all of the one or more items of raw data related to the event that has occurred in monitored object 1. Accordingly, it is possible to prevent an increase in the number of analyses performed on the one or more items of raw data. Analysis support device 20 includes collator 21, storage 22, and display 23.

Collator 21 is an example of an obtainer that obtains raw data related to an event that has occurred in monitored object 1. For example, collator 21 obtains the raw data by communicating with monitored object 1 or communicating with a database that stores the raw data obtained from monitored object 1. Moreover, for example, collator 21 further obtains a determination result obtained by a security information and event management device (not illustrated) based on the raw data. Collator 21 may obtain only the raw data among the raw data related to the event that has occurred in monitored object 1 and the determination result obtained by the security information and event management device based on the raw data. For example, collator 21 obtains information that includes the raw data related to the event that has occurred in monitored object 1 and the determination result obtained by the security information and event management device based on the raw data. In the present embodiment, such information may be referred to as event information.

For example, each item of raw data includes a plurality of entries. For example, the plurality of entries include an entry that indicates the content and the like of the event that has occurred in monitored object 1, an entry that indicates the type of monitored object 1, an entry that indicates the location where the event has occurred in monitored object 1, and an entry that indicates the type of the event that has occurred in monitored object 1. For example, the determination result indicates the details of the event that has occurred in monitored object 1.

Collator 21 is an example of an outputter that outputs the previous analysis result for previously obtained raw data similar to the obtained raw data. For example, the previous analysis result may be an analysis result obtained by machine or human.

For example, one or more items of previously obtained event information and the previous analysis result for each of the one or more items of previously obtained event information are stored in storage 22. For example, collator 21 reads one or more items of previously obtained event information from storage 22, and collates the obtained event information with each of the one or more items of read event information. For example, collator 21 determines whether the one or more items of read event information include event information that includes raw data similar to the raw data included in the obtained event information and a determination result similar to the determination result included in the obtained event information. When the one or more items of read event information include such event information, collator 21 outputs the previous analysis result for the event information. For example, when the content of the raw data included in the obtained event information is identical to the content of the raw data included in the read event information, collator 21 determines that the raw data included in the obtained event information is similar to the raw data included in the read event information. For example, when the content of the determination result included in the obtained event information is identical to the content of the determination result included in the read event information, collator 21 determines that the determination result included in the obtained event information is similar to the determination result included in the read event information.

Display 23 displays the analysis result output by collator 21.

For example, collator 21 is realized by a processor or the like, storage 22 is realized by a memory or the like, and display 23 is realized by a liquid crystal display, an organic electro-luminescent (EL) display, or the like.

The functional configuration of analysis support device 20 and the like has been described above.

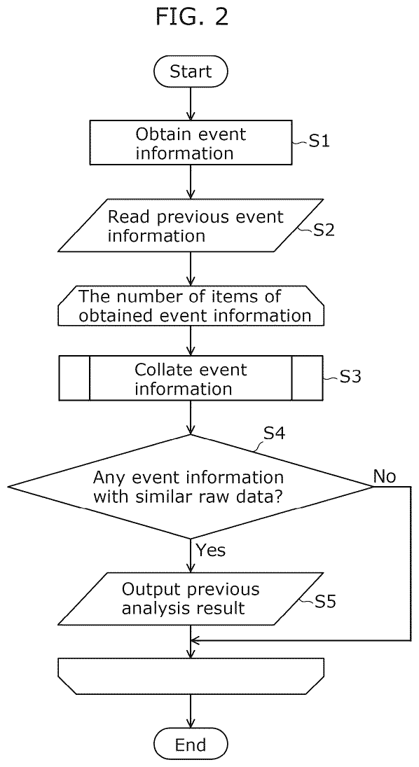

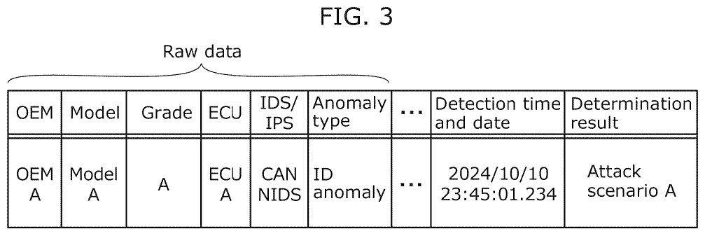

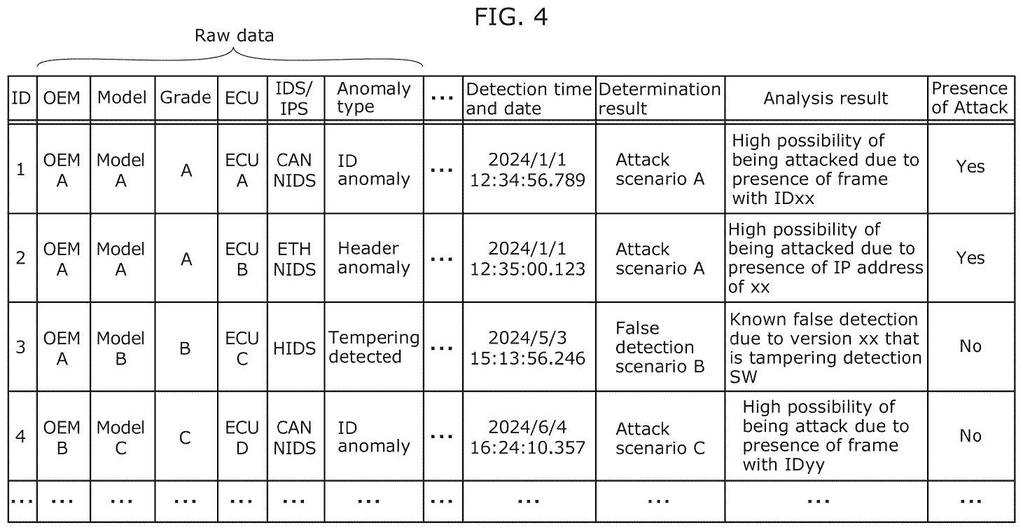

FIG. 2 is a flowchart illustrating an example of an operation of analysis support device 20 illustrated in FIG. 1. FIG. 3 is a table illustrating event information obtained by analysis support device 20 in FIG. 1. FIG. 4 is a table illustrating a group of event information stored in analysis support device 20 in FIG. 1. Referring to FIG. 2 to FIG. 4, an example of an operation of analysis support device 20 will be described.

As illustrated in FIG. 2, first, collator 21 obtains event information related to an event that has occurred in monitored object 1 (step S1). Examples of the event that has occurred in monitored object 1 is an unauthorized intrusion into monitored object 1 and an attack on monitored object 1. For example, the event information includes: one item of raw data related to an event that has occurred in monitored object 1; and one determination result obtained by the security information and event management device based on the raw data. For example, the raw data related to the event that has occurred in monitored object 1 is a log related to the event. For example, it is assumed that an event has occurred in monitored object 1. In this case, monitored object 1 outputs raw data related to the event, the security information and event management device makes a determination based on the raw data and outputs determination result, and collator 21 obtains event information including the raw data and the determination result. For example, by obtaining the event information, collator 21 obtains raw data related to the event that has occurred in monitored object 1 and the determination result obtained by the security information and event management device based on the raw data. For example, collator 21 may obtain only the raw data among the raw data and the determination result.

For example, as illustrated in FIG. 3, event information includes raw data and a determination result. The raw data includes a plurality of entries. The plurality of entries include the original equipment manufacturer (OEM) of monitored object 1, the model of monitored object 1, the grade of monitored object 1, the ECU of monitored object 1, the monitoring methods of IDS/IPS of monitored object 1, and the anomaly type in monitored object 1. The determination result is a result of determination performed by the security information and event management device based on the raw data.

Referring to FIG. 2 again, when obtaining event information, collator 21 reads one or more items of previously obtained event information (step S2). As described above, for example, the one or more items of previously obtained event information are stored in storage 22, and collator 21 reads the one or more items of previously obtained event information from storage 22.

For example, as illustrated in FIG. 4, storage 22 stores one or more items of event information, a previous analysis result for each of the one or more items of event information, and a determination result related to presence of an attack. In other words, the analysis result is the result of analysis based on the event information, and the determination result is the result of determination based on the event information. For example, collator 21 reads one or more items of event information as illustrated in FIG. 4.

Referring to FIG. 2 again, after reading one or more items of previously obtained event information, collator 21 then collates the event information obtained in step S1 with each of the one or more items of previously obtained event information (step S3). For example, collator 21 collates the obtained event information with each of the one or more items of read event information. Collator 21 then determines whether the one or more items of read event information include event information that includes raw data similar to the raw data included in the obtained event information and a determination result similar to the determination result included in the obtained event information. For example, collator 21 may obtain only the raw data among the raw data and the determination result, and collate the obtained raw data with the one or more items of previously obtained raw data.

For example, when reading one or more items of event information as illustrated in FIG. 4, collator 21 sequentially collates the obtained event information with the read event information starting from the event information with ID1. Collator 21 then determines whether the one or more items of read event information include event information that includes raw data similar to the raw data included in the obtained event information and a determination result similar to the determination result included in the obtained event information.

After collating the event information obtained in step S1, collator 21 determines whether the one or more items of read event information include event information that includes raw data similar to the raw data included in the obtained event information (step S4). For example, collator 21 may obtain only the raw data among the raw data and the determination result, and determine whether the one or more items of previously obtained raw data include raw data similar to the obtained raw data.

For example, collator 21 obtains event information as illustrated in FIG. 3. When collator 21 reads one or more items of event information as illustrated in FIG. 4, the content of the raw data included in the obtained event information is identical to the content of the raw data in the read event information with ID1. Therefore, collator 21 determines that the read event information includes raw data similar to the raw data included in the obtained event information, and determines that the one or more items of read event information include event information that includes raw data similar to the raw data included in the obtained event information.

Referring to FIG. 2 again, when the one or more items of read event information include event information that includes raw data similar to the raw data included in the obtained event information (Yes in step S4), collator 21 outputs the previous analysis result for the read event information (step S5). For example, collator 21 may output the previous analysis result for the event information, among the one or more items of read event information, which includes raw data similar to the raw data included in the obtained event information and includes a determination result similar to the determination result included in the obtained event information. In other words, collator 21 may output the previous analysis result for the previously obtained raw data and determination result that are similar to the obtained raw data and determination result. Moreover, for example, collator 21 may obtain only the raw data among the raw data and the determination result, and when the one or more items of previously obtained raw data include raw data similar to the obtained raw data, collator 21 may output the previous analysis result for the similar raw data.

Collator 21 outputs no analysis result when the one or more items of read event information include no event information that includes raw data similar to the raw data included in the obtained event information (No in step S4).

An example of the operation of analysis support device 20 has been described above.

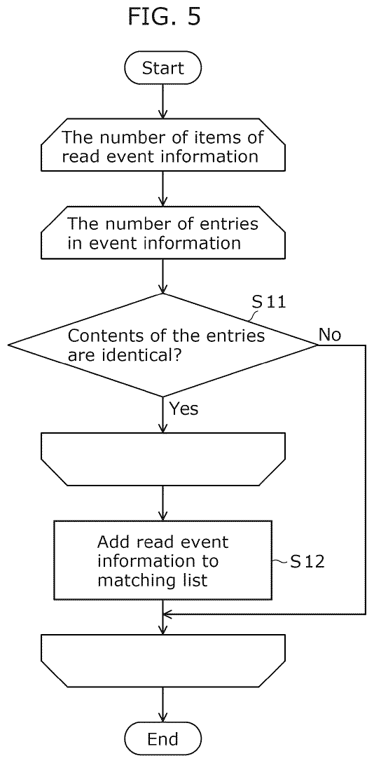

FIG. 5 is a flowchart illustrating an example of an operation included in step S3 of FIG. 2. Referring to FIG. 2, FIG. 3, and FIG. 5, an example of the operation included in step S3 of FIG. 2 will be described.

As illustrated in FIG. 5, collator 21 collates the content of each of the plurality of entries included in the obtained event information with the content of each of the plurality of entries included in each of the one or more items of read event information. For example, collator 21 may obtain only the raw data among the raw data and the determination result, and collate the content of each of the plurality of entries included in the obtained raw data with the content of each of the plurality of entries included in each of one or more items of previously obtained raw data.

First, collator 21 determines whether the content of the first entry of the plurality of entries included in the first event information among the one or more items of read event information is identical to the content of the first entry of the plurality of entries included in the obtained event information (step S11).

For example, collator 21 obtains event information as illustrated in FIG. 3. When reading one or more items of event information as illustrated in FIG. 4, collator 21 determines whether the content of the OEM included in the read event information with ID1 is identical to the content of the OEM included in the obtained event information.

When the content of the first entry of the plurality of entries included in the first event information among the one or more items of read event information is identical to the content of the first entry of the plurality of entries included in the obtained event information (Yes in step S11), collator 21 determines whether the content of the second entry of the plurality of entries included in the first event information among the one or more items of read event information is identical to the content of the second entry of the plurality of entries included in the obtained event information (step S11).

In such a manner, when the content of the n-th entry of the plurality of entries included in the first event information among one or more items of read event information is identical to the content of the n-th entry of the plurality of entries included in the obtained event information (Yes in step S11), collator 21 determines whether the content of the n+1th entry of the plurality of entries included in the first event information among the one or more items of read event information is identical to the content of the n+1th entry of the plurality of entries included in the obtained event information.

When the content of each of the plurality of entries included in the first event information among the one or more items of read event information is identical to the content of each of the plurality of entries included in the obtained event information, collator 21 adds the first event information among the one or more items of read event information to a matching list (step S12).

When the content of the first entry of the plurality of entries included in the first event information among the one or more items of read event information is not identical to the content of the first entry of the plurality of entries included in the obtained event information (No in step S11), and when the first event information among the one or more items of read event information is added to the matching list (step S12), collator 21 determines whether the content of the first entry of a plurality of entries included in the second event information among the one or more items of read event information is identical to the content of the first entry of the plurality of entries included in the obtained event information (step S11).

After collating the content of each of the plurality of entries included in the obtained event information with the content of each of the plurality of entries included in each of the one or more items of read event information, collator 21 outputs the previous analysis result for the event information added to the matching list. In such a manner, when the one or more items of read event information include event information that includes raw data similar to the raw data included in the obtained event information, collator 21 determines that the one or more items of read event information include raw data similar to the raw data included in the obtained event information, and outputs the previous analysis result for the similar event information. For example, it may be that collator 21 obtains only the raw data among the raw data and the determination result, and when the one or more items of previously obtained raw data include raw data that includes a plurality of entries with the same contents as the plurality of entries included in the obtained raw data, collator 21 determines that the one or more items of previously obtained raw data include the raw data similar to the obtained raw data. Collator 21 may then output the previous analysis result for the similar raw data.

An example of the operation included in step S3 of FIG. 2 has been described.

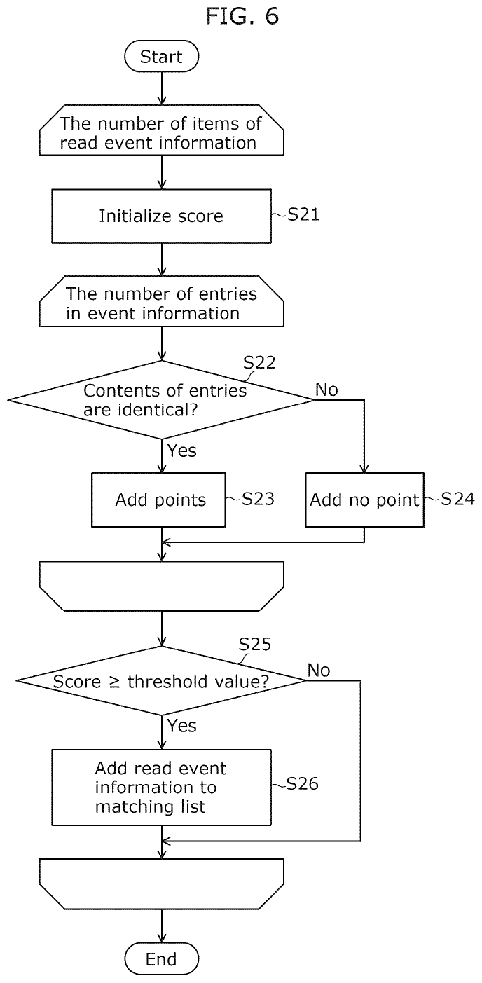

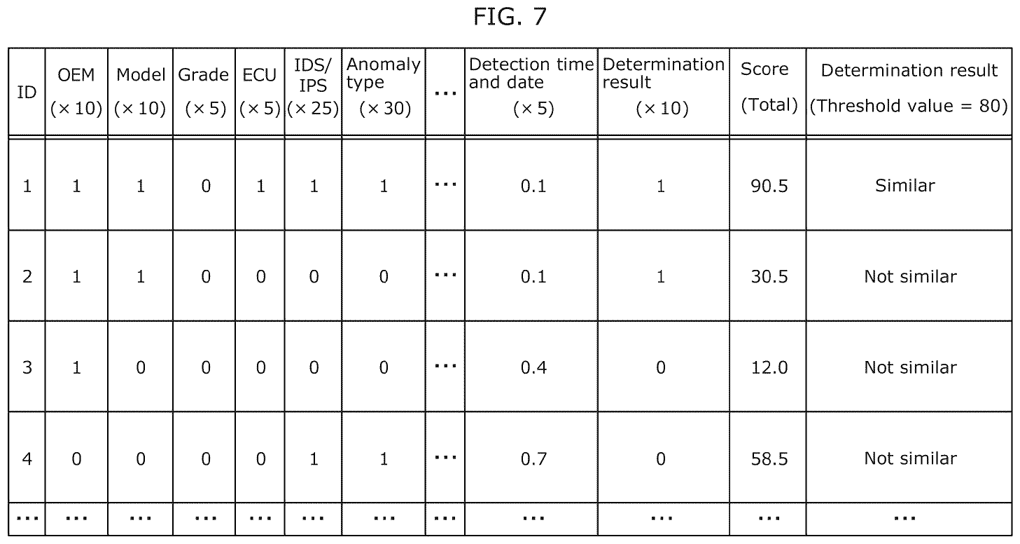

FIG. 6 is a flowchart illustrating another example of the operation included in step S3 of FIG. 2. FIG. 7 is an explanatory table for illustrating another example of the operation included in step S3 of FIG. 2. Referring to FIG. 6 and FIG. 7, another example of the operation included in step S3 of FIG. 2 will be described.

As illustrated in FIG. 6, collator 21 collates the content of each of the plurality of entries included in the obtained event information with the content of each of the plurality of entries included in each of the one or more items of read event information. Collator 21 adds points when the content of each of the plurality of entries included in the obtained event information is identical to the content of a corresponding one of the plurality of entries included in each of the one or more items of read event information. Collator 21 adds no points or deduct points when the content of each of the plurality of entries included in the obtained event information is not identical to the content of the corresponding one of the plurality of entries included in each of the one or more items of read event information. In this way, collator 21 calculates a score for each of the one or more items of read event information.

First, collator 21 initializes the score of the first event information among the one or more items of previously obtained event information (step S21). For example, collator 21 sets the score of the first event information among the one or more items of previously obtained event information to 0.

Collator 21 determines whether the content of the first entry of the plurality of entries included in the first event information among the one or more items of previously obtained event information is identical to the content of the first entry of the plurality of entries included in the obtained event information (step S22).

When the content of the first entry of the plurality of entries included in the first event information among the one or more items of previously obtained event information is identical to the content of the first entry of the plurality of entries included in the obtained event information (Yes in step S22), collator 21 adds points (step S23).

For example, as illustrated in FIG. 7, collator 21 adds points when the content of the OEM which is the first entry of the plurality of entries included in the first event information among the one or more items of previously obtained event information is identical to the content of the OEM which is the first entry of the plurality of entries included the obtained event information. For example, a score calculated by 1×weighting factor is added. For example, the weighting factor is set in advance.

Referring to FIG. 6 again, when the content of the first entry of the plurality of entries included in the first event information among the one or more items of previously obtained event information is not identical to the content of the first entry of the plurality of entries included in the obtained event information (No in step S22), collator 21 adds no points or deducts points (step S24).

When collator 21 added no points, or deducted points for the first entry of the plurality of entries included in the first event information among the one or more items of previously obtained event information, collator 21 determines whether the content of the second entry of the plurality of entries included in the first event information among the one or more items of previously obtained event information is identical to the content of the second entry of the plurality of entries included in the obtained event information (step S22).

After calculating the score of the first event information among the one or more items of previously obtained event information, collator 21 determines whether the score is greater than or equal to a predetermined threshold value (step S25).

When the score is greater than or equal to the predetermined threshold value (Yes in step S25), collator 21 adds the first event information among the one or more items of previously obtained event information to the matching list (step S26).

When the score is not greater than or equal to the predetermined threshold value (No in step S25) and the first event information among the one or more items of previously obtained event information is added to the matching list (step S26), collator 21 initializes the score of the second event information among the one or more items of previously obtained event information (step S21), and calculates the score for the second event information.

After calculating the score for each of the one or more items of read event information, collator 21 outputs the previous analysis result for the event information added to the matching list. In such a manner, when the one or more items of read event information include event information with a calculated score that is greater than or equal to the predetermined threshold value, collator 21 determines that the one or more items of read event information include event information that includes raw data similar to the raw data included in the obtained event information, and outputs the previous analysis result for the event information.

For example, collator 21 may obtain only the raw data among the raw data and the determination result, and collate the content of each of the plurality of entries included in the obtained raw data with the content of each of the plurality of entries included in each of the one or more items of previously obtained raw data. Collator 21 may add points when the content of each of the plurality of entries included in the obtained raw data is identical to the content of a corresponding one of the plurality of entries included in each of the one or more items of previously obtained raw data. Collator 21 may add no points or deduct points when the content of each of the plurality of entries included in the obtained raw data is not identical to the content of the corresponding one of the plurality of entries included in each of the one or more items of previously obtained raw data. In this way, collator 21 may calculate a score for each of the one or more items of previously obtained raw data. When the one or more items of previously obtained raw data include raw data with a calculated score that is greater than or equal to the predetermined threshold value, collator 21 may determine that the one or more items of previously obtained raw data include raw data similar to the obtained raw data, and output the previous analysis result for the similar raw data.

Another example of the operation included in step S3 in FIG. 2 has been described.

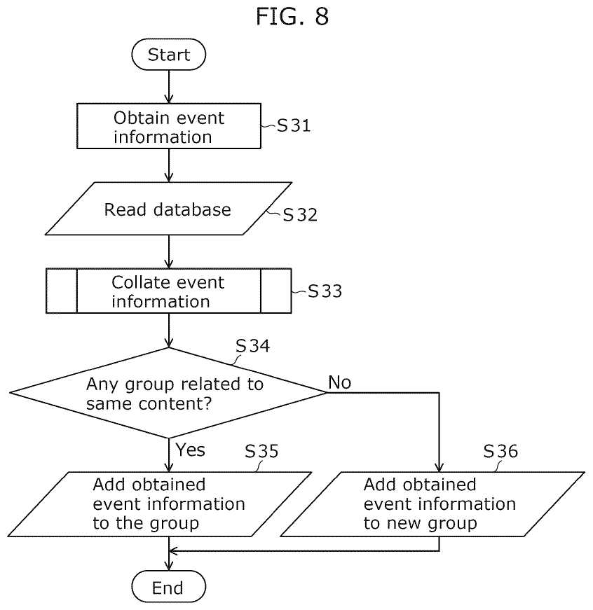

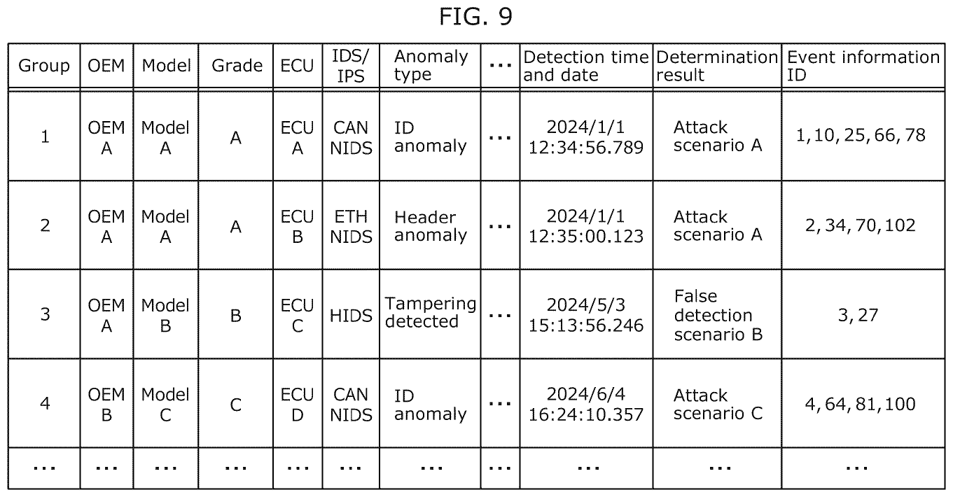

FIG. 8 is a flowchart illustrating another example of the operation of analysis support device 20 illustrated in FIG. 1. FIG. 9 is a table illustrating one or more groups. Referring to FIG. 8 and FIG. 9, another example of the operation of analysis support device 20 will be described.

As illustrated in FIG. 9, one or more items of previously obtained event information are classified into one or more groups according to the content of each of a plurality of entries. That is, for example, the content of each of a plurality of entries of one or more items of event information belonging to the same group is identical to each other. The content of each of a plurality of entries of one or more items of event information belonging to different groups is different from each other. When the one or more groups include a group that has the same contents as the plurality of entries included in the obtained event information, collator 21 classifies the obtained event information into the group. When the one or more groups does not include a group that has the same contents as the plurality of entries included in the obtained event information, collator 21 classifies the obtained event information into a new group.

As illustrated in FIG. 8, first, collator 21 obtains event information (step S31), and reads database (step S32). For example, as illustrated in FIG. 9, a database includes one or more items of event information classified into one or more groups according to the content of each of a plurality of entries.

After reading the database, collator 21 collates the obtained event information with each of the one or more groups included in the read database (step S33).

Collator 21 determines whether the one or more groups stored in the database include a group related to the same content as the content of each of the plurality of entries included in the obtained event information (step S34).

When the one or more groups stored in the database include a group related to the same content as the content of each of the plurality of entries included in the obtained event information (Yes in step S34), collator 21 classifies the obtained event information into the group by adding the obtained event information to the group (step S35).

When the one or more groups stored in the database include no group related to the same content as the content of each of the plurality of entries included in the obtained event information (No in step S34), collator 21 classifies the obtained event information into a new group by adding the obtained event information to the new group (step S36).

For example, among the one or more items of previously obtained raw data and the one or more determination results previously obtained based on the one or more items of previously obtained raw data, only the one or more items of previously obtained raw data may be classified into the one or more groups according to the content of each of the plurality of entries. When the one or more groups include a group related to the same content as the content of each of the plurality of entries included in the obtained raw data, collator 21 may classify the obtained raw data to the group. When the one or more groups do not include a group related to the same content as the content of each of the plurality of entries included in the obtained raw data, collator 21 may classify the obtained raw data to a new group.

Another example of the operation of analysis support device 20 has been described above.

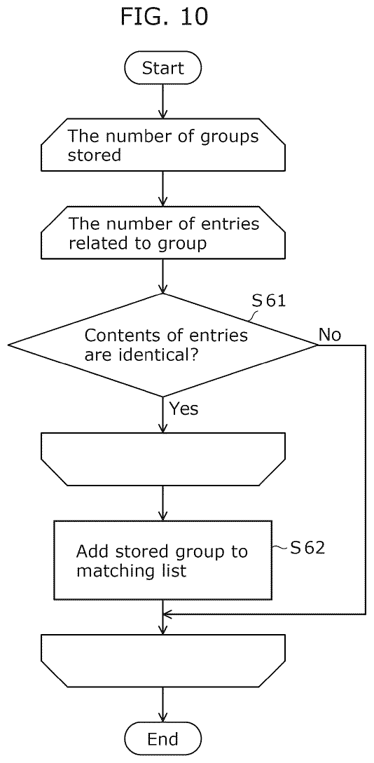

FIG. 10 is a flowchart illustrating another example of the operation included in step S3 of FIG. 2. Referring to FIG. 10, another example of the operation included in step S3 of FIG. 2 will be described.

As illustrated in FIG. 10, collator 21 collates the content of each of a plurality of entries included in the obtained event information with the content of each of a plurality of entries related to each of one or more groups. For example, collator 21 may obtain only the raw data among the raw data and the determination result, and collate the content of each of the plurality of entries included in the obtained raw data with the content of each of the plurality of entries related to each of the one or more groups.

First, collator 21 determines whether the content of the first entry of the plurality of entries related to the first group of the one or more groups is identical to the content of the first entry of the plurality of entries included in the obtained event information (step S61).

For example, collator 21 obtains event information as illustrated in FIG. 3. When reading one or more groups as illustrated in FIG. 9, collator 21 determines whether the content of the OEM related to read group 1 is identical to the content of the OEM included in the obtained event information.

When the content of the first entry of the plurality of entries included in the first group of the one or more groups is identical to the content of the first entry of the plurality of entries included in the obtained event information (Yes in step S61), collator 21 determines whether the content of the second entry of the plurality of entries included in the first group of the one or more groups is identical to the content of the second entry of the plurality of entries included in the obtained event information (step S61).

In such a manner, when the content of the n-th entry of the plurality of entries included in the first group of the one or more groups is identical to the content of the n-th entry of the plurality of entries included in the obtained event information (Yes in step S61), collator 21 determines whether the content of the n+1th entry of the plurality of entries included in the first group of the one or more groups is identical to the content of the n+1th entry of the plurality of entries included in the obtained event information.

When the content of each of the plurality of entries included in the first group of the one or more groups is identical to the content of each of the plurality of entries included in the obtained event information, collator 21 adds the first event information among the one or more items of read event information to a matching list (step S62).

When the content of the first entry of the plurality of entries included in the first group of the one or more groups is not identical to the content of the first entry of the plurality of entries included in the obtained event information (No in step S61), and when the first group of the one or more groups is added to the matching list (step S62), collator 21 determines whether the content of the first entry of the plurality of entries included in the second group of the one or more groups is identical to the content of the first entry of the plurality of entries included in the obtained event information (step S61).

After collating the content of each of the plurality of entries included in the obtained event information with the content of each of the plurality of entries included in each of the one or more groups, collator 21 outputs the previous analysis result for the event information added to the matching list. In such a manner, when the one or more groups include a group related to the same content as the content of each of the plurality of entries included in the obtained event information, collator 21 determines that the one or more groups include event information that includes raw data similar to the raw data included in the obtained event information, and outputs the previous analysis result for the event information. For example, collator 21 may obtain only the raw data among the raw data and the determination result, and collate the content of each of the plurality of entries included in the obtained raw data with the content of each of the plurality of entries related to each of the one or more groups. When the one or more groups include a group related to the same content as the content of each of the plurality of entries included in the obtained raw data, collator 21 may determine that the one or more items of previously obtained raw data include raw data similar to the obtained raw data, and output the previous analysis result for the similar raw data.

Another example of the operation included in step S3 of FIG. 2 has been described.

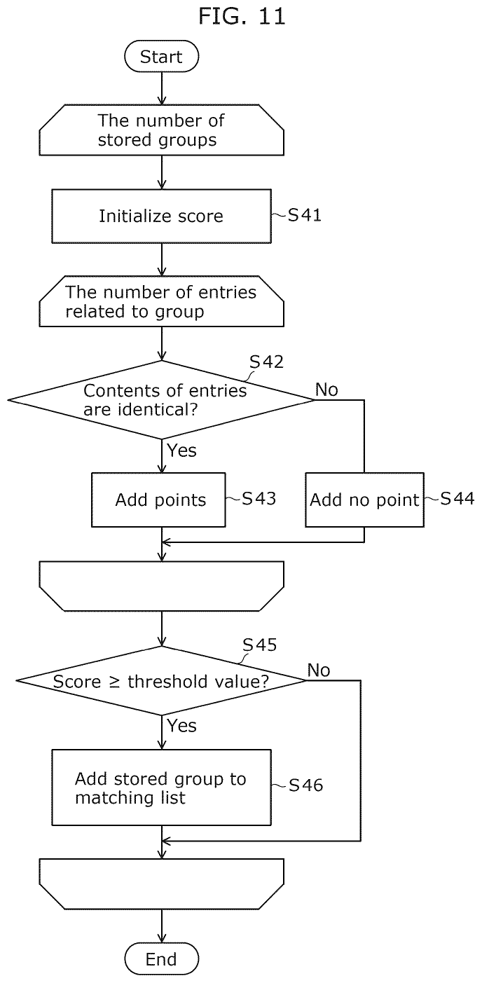

FIG. 11 is a flowchart illustrating another example of the operation included in step S3 of FIG. 2. Referring to FIG. 11, another example of the operation included in step S3 of FIG. 2 will be described.

As illustrated in FIG. 11, collator 21 collates the content of each of the plurality of entries included in the obtained event information with the content of each of the plurality of entries related to one or more groups. Collator 21 adds points when the content of each of the plurality of entries included in the obtained event information is identical to the content of a corresponding one of the plurality of entries related to each of the one or more groups. Collator 21 adds no points or deducts points when the content of each of the plurality of entries included in the obtained event information is not identical to the content of the corresponding one of the plurality of entries related to each of the one or more groups. In this way, collator 21 calculates a score for each of the one or more groups.

First, collator 21 initializes the score of the first group among one or more groups (step S41). For example, collator 21 sets the score of the first group of the one or more groups to 0.

Collator 21 determines whether the content of the first entry of the plurality of entries related to the first group of the one or more groups is identical to the content of the first entry of the plurality of entries included in the obtained event information (step S42).

When the content of the first entry of the plurality of entries related to the first group of the one or more groups is identical to the content of the first entry of the plurality of entries included in the obtained event information (Yes in step S42), collator 21 adds points (step S43).

For example, as illustrated in FIG. 9, collator 21 adds points when the content of the OEM which is the first entry of the plurality of entries related to the first group of the one or more groups is identical to the content of the OEM which is the first entry of the plurality of entries included in the obtained event information. For example, a score calculated by 1×weighting factor is added. For example, the weighting factor is set in advance.

Referring to FIG. 11 again, when the content of the first entry of the plurality of entries related to the first group of the one or more groups is not identical to the content of the first entry of the plurality of entries included in the obtained event information (No in step S42), collator 21 adds no points or deducts points (step S44).

When adding points, adding no points, or deducting points for the first entry of the plurality of entries related to the first group of the one or more groups, collator 21 determines whether the content of the second entry of the plurality of entries related to the first group of the one or more groups is identical to the content of the second entry of the plurality of entries included in the obtained event information (step S42).

After calculating the score for the first group among the one or more groups, collator 21 determines whether the score is greater than or equal to a predetermined threshold value (step S45).

When the score is greater than or equal to the predetermined threshold value (Yes in step S45), collator 21 adds the first group of the one or more groups to the matching list (step S46).

When the score is not greater than or equal to the predetermined threshold value (No in step S45), and when the first group among the one or more groups is added to the matching list (step S46), collator 21 initializes the score of the second group among the one or more groups (step S41), and calculates the score for the second group.

After calculating the score for each of the one or more groups, collator 21 outputs the previous analysis result for the group added to the matching list. In such a manner, when the one or more groups include a group with a calculated score that is greater than or equal to the predetermined threshold value, collator 21 determines that the raw data included in the obtained event information is similar to the raw data included in the event information belonging to the group, determines that the one or more items of previously obtained event information include event information that includes raw data similar to the raw data included in the obtained event information, and outputs the previous analysis result for the event information.

For example, collator 21 may obtain only the raw data among the raw data and the determination result, and collate the content of each of the plurality of entries included in the obtained raw data with the content of each of the plurality of entries related to each of the one or more groups. Collator 21 may add points when the content of each of the plurality of entries included in the obtained raw data is identical to the content of a corresponding one of the plurality of entries related to each of the one or more groups. collator 21 may add no points or deduct points when the content of each of the plurality of entries included in the obtained event information is not identical to the content of the corresponding one of the plurality of entries related to each of the one or more groups. In this way, collator 21 may calculate a score for each of the one or more groups. When the one or more groups include a group with a calculated score that is greater than or equal to the predetermined threshold value, collator 21 may determine that the one or more items of previously obtained raw data include raw data similar to the obtained raw data, and output the previous analysis result for the similar raw data.

Another example of the operation included in step S3 of FIG. 2 has been described.

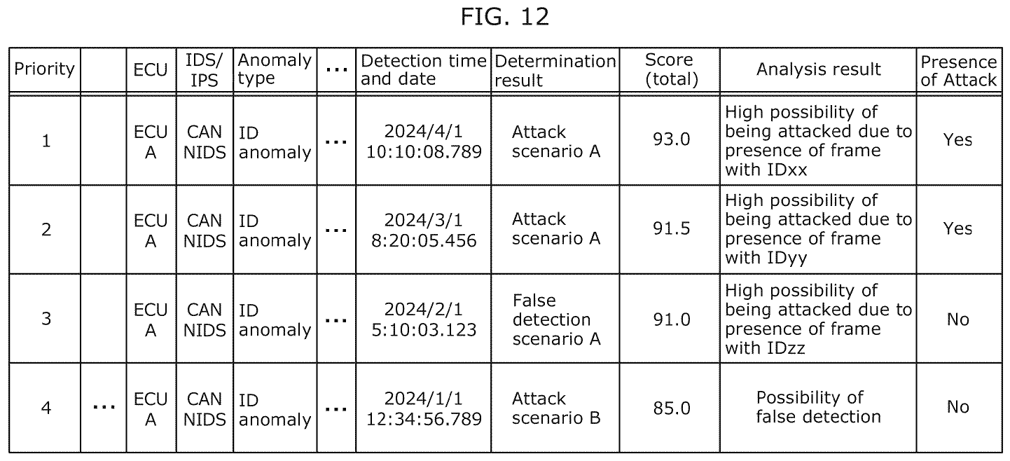

FIG. 12 is a table illustrating an example of a display shown on analysis support device 20 in FIG. 1. Referring to FIG. 12, an example of a display shown on analysis support device 20 will be described.

As illustrated in FIG. 12, for example, display 23 displays one or more items of previously obtained event information in descending order of score. In other words, for example, display 23 more preferentially displays the previous analysis result for event information with a higher degree of similarity to the obtained event information.

An example of a display shown on analysis support device 20 has been described.

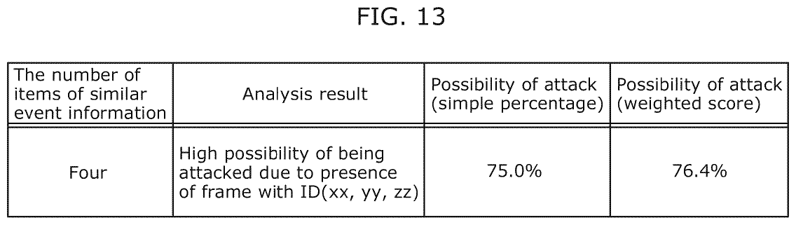

FIG. 13 is a table illustrating another example of the display shown on analysis support device 20 in FIG. 1. Referring to FIG. 13, another example of the display shown on analysis support device 20 will be described.

As illustrated in FIG. 13, for example, display 23 collectively displays one or more items of event information with similar contents or with similar analysis results among a plurality of items of previously obtained event information.

Another example of the display shown on analysis support device 20 has been described.

As described above, the analysis support method according to Embodiment 1 is capable of: (i) reducing an increase in the number of analyses performed on one or more items of raw data related to the event that has occurred in monitored object 1; (ii) reducing an increase in operating hours of a device and the like used to analyze the event; and (iii) reducing an increase and the like in the consumption of electric power used to operate the device.

The analysis support method according to Embodiment 1 is an analysis support method executed by analysis support device 20 that supports an analysis of an attack scenario in an event that has occurred in monitored object 1. The analysis is performed based on raw data related to the event. The analysis support method includes: the raw obtaining data by communicating with monitored object 1 or communicating with a database that stores the raw data obtained from monitored object 1 (step S1); and outputting a previous analysis result for the previously obtained raw data similar to the obtained raw data (step S5).

With this, it is possible to output the previous analysis result for previously obtained raw data similar to the obtained raw data. This allows the previous analysis result for the raw data similar to the obtained raw data to be output without analyzing the obtained raw data, and reduces an increase in the number of analyses performed on one or more items of raw data related to an event that has occurred in monitored object 1.

An analysis support method according to Embodiment 1 is an analysis support method performed by analysis support device 20 that supports an analysis of an attack scenario in an event that has occurred in monitored object 1. The analysis is performed based on raw data related to the event. The analysis support method includes: obtaining the raw data and a determination result that is obtained by a security information and event management device based on the raw data; and outputting a previous analysis result for previously obtained raw data and a previously obtained determination result that are similar to the raw data obtained and the determination result obtained.

With this, it is possible to output the previous analysis result for the previously obtained raw data and determination result that are similar to the obtained raw data and determination result. This allows the analysis result for the raw data and determination result similar to the obtained raw data and determination result to be output without analyzing the obtained raw data and determination result, and reduces an increase in the number of analyses performed on one or more items of raw data related to an event that has occurred in monitored object 1.

The analysis support method according to Embodiment 1, includes: collating the raw data obtained with each of one or more items of previously obtained raw data (step S3); determining whether the one or more items of previously obtained raw data include similar raw data that is similar to the raw data obtained (step S4); and when the one or more items of previously obtained raw data include the similar raw data, outputting a previous analysis result for the similar raw data (step S5).

With this, when raw data similar to the obtained raw data is available, the analysis result for the similar raw data can be output. This allows the analysis result for the raw data similar to the obtained raw data to be output without analyzing the obtained raw data, and reduces an increase in the number of analyses performed on a plurality of items of raw data related to an event that has occurred in monitored object 1.

The analysis support method according to Embodiment 1, in which the raw data includes a plurality of entries, includes: collating a content of each of the plurality of entries included in the raw data obtained with a content of each of a plurality of entries included in each of the one or more items of previously obtained raw data (step S11); and when the one or more items of previously obtained raw data include raw data that includes a plurality of entries that are identical in content to the plurality of entries included in the raw data obtained, determining that the one or more items of previously obtained raw data include the similar raw data (Yes in step S4).

With this, it is possible to output the analysis result for raw data including a plurality of entries with the same contents as the contents of the plurality of entries included in the obtained raw data among the one or more items of previously obtained raw data. This allows an analysis result with a higher accuracy to be output.

The analysis support method according to Embodiment 1, in which the raw data includes a plurality of entries, includes: collating a content of each of the plurality of entries included in the raw data obtained with a content of each of the plurality of entries included in each of the one or more items of previously obtained raw data (step S22); calculating a score for each of the one or more items of previously obtained raw data, by (i) adding a point when the content of each of the plurality of entries included in the raw data obtained is identical to a content of a corresponding one of the plurality of entries included in each of the one or more items of previously obtained raw data (step S23), and (ii) adding no point or deducting a point when the content of each of the plurality of entries included in the raw data obtained is not identical to the content of the corresponding one of the plurality of entries included in each of the one or more items of previously obtained raw data (step S24); and when the one or more items of previously obtained raw data include raw data with a calculated score that is greater than or equal to a predetermined threshold value (Yes in step S25), determining that the one or more items of previously obtained raw data include the similar raw data (Yes in step S4).

With this, it is possible to output an analysis result for the raw data with a calculated score that is greater than or equal to a predetermined threshold value among the one or more items of previously obtained raw data. This allows an analysis result with a higher accuracy to be output.

The analysis support method according to Embodiment 1, in which the raw data includes a plurality of entries and the one or more items of previously obtained raw data are classified into one or more groups according to each of the plurality of entries, includes: when the one or more groups include a group related to a content identical to a content of each of the plurality of entries included in the raw data obtained, classifying the raw data obtained into the group (step S35); and when the one or more groups include no group related to the content identical to the content of each of the plurality of entries included in the raw data obtained, classifying the raw data obtained into a new group (step S36).

This makes it easy to recognize, for example, whether raw data similar to the obtained raw data has been previously obtained.

The analysis support method includes: collating the content of each of the plurality of entries included in the raw data obtained with a content of each of the plurality of entries related to each of the one or more groups; and when the one or more groups include a group related to a content identical to the content of each of the plurality of entries included in the raw data obtained, determining that the one or more items of previously obtained raw data include raw data similar to the raw data obtained.

With this, it is possible to output the analysis result for the raw data belonging to the group related to the same content as the content of each of the plurality of entries included in the obtained raw data among the one or more groups. This allows raw data similar to the obtained raw data to be efficiently found, and an analysis result with a higher accuracy to be output.

The analysis support method according to Embodiment 1, includes: collating the content of each of the plurality of entries included in the raw data obtained with a content of each of the plurality of entries related to each of the one or more groups (step S42); calculating a score for each of the one or more groups, by (i) adding a point when the content of each of the plurality of entries included in the raw data obtained is identical to a content of a corresponding one of the plurality of entries related to each of the one or more groups (step S43), and (ii) adding no point or deducting a point when the content of each of the plurality of entries included in the raw data obtained is not identical to the content of the corresponding one of the plurality of entries related to each of the one or more groups (step S44); and when the one or more groups include a group with a calculated score that is greater than or equal to a predetermined threshold value (Yes in step S45), determining that the one or more items of previously obtained raw data include raw data similar to the raw data obtained (Yes in step S4).

With this, it is possible to output the analysis result for the raw data belonging to a group with a calculated score that is greater than or equal to a predetermined threshold value among the one or more groups. This allows raw data similar to the obtained raw data to be efficiently found, and an analysis result with a higher accuracy to be output.

Analysis support device 20 according to Embodiment 1 is an analysis support device that supports an analysis of an attack scenario in an event that has occurred in monitored object 1. The analysis is performed based on raw data related to the event. Analysis support device 20 includes: an obtainer (collator 21) that obtains the raw data; and an outputter (collator 21) that outputs an analysis result for previously obtained raw data that is similar to the raw data obtained.

With this, the same advantageous effects as those of the analysis support method described above can be obtained.

### Embodiment 2

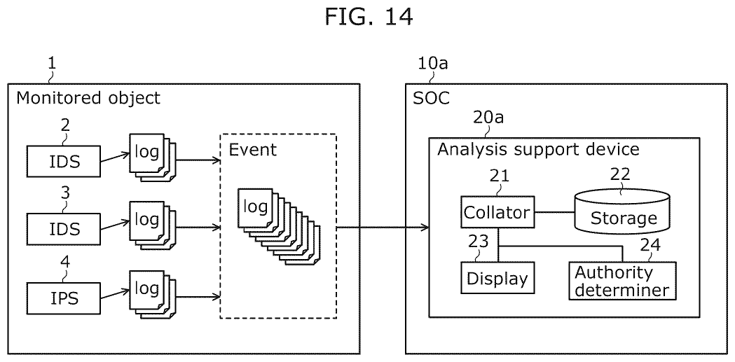

FIG. 14 is a block diagram illustrating a functional configuration of analysis support device 20a and the like according to Embodiment 2. Referring to FIG. 14, a functional configuration of analysis support device 20a and the like will be described.

As illustrated in FIG. 14, SOC 10a mainly differs from SOC 10 in that analysis support device 20a is included instead of analysis support device 20. Analysis support device 20a mainly differs from analysis support device 20 in that authority determiner 24 is further included.

When one or more items of read event information include event information that includes raw data similar to the raw data included in the obtained event information and a determination result similar to the determination result included in the obtained event information, authority determiner 24 determines whether a user is authorized to view the previous analysis result for the event information. Moreover, for example, collator 21 obtains only the raw data among the raw data and the determination result. When the one or more items of previously obtained raw data include raw data similar to the obtained raw data, authority determiner 24 determines whether the user is authorized to view the previous analysis result for the similar raw data. For example, analysis support device 20a receives an input of login information for the user to use analysis support device 20a. Authority determiner 24 refers to the input login information to determine whether the user is authorized to view the event information or the previous analysis result for the similar raw data. For example, login information to which a viewing authorization has been given is stored in advance. When the entered login information matches the login information stored in advance, authority determiner 24 determines that the user is authorized to view the event information or the previous analysis result for the similar raw data. When the entered login information does not match the stored login information, authority determiner 24 determines that the user is not authorized to view the event information or the previous analysis result for the similar raw data.

The functional configuration of analysis support device 20a and the like has been described above.

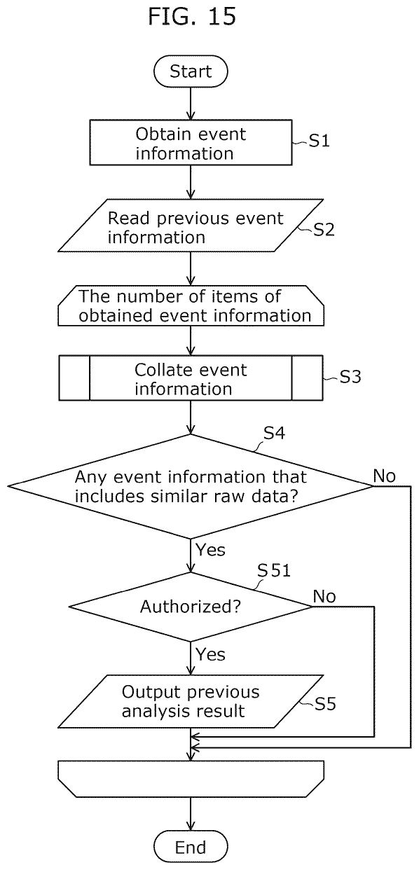

FIG. 15 is a flowchart illustrating an example of an operation of analysis support device 20a illustrated in FIG. 14. Referring to FIG. 15, an example of an operation of analysis support device 20a will be described. Features that differ from the example of the operation illustrated in FIG. 2 will be mainly described below.

As illustrated in FIG. 15, when the read event information includes raw data similar to the raw data included in the obtained event information (Yes in step S4), authority determiner 24 determines whether the user is authorized to view the previous analysis result for the read event information (step S51).

When the user is authorized to view the previous analysis result for the read event information (Yes in step S51), collator 21 outputs the previous analysis result for the event information (step S5).

When the user is not authorized to view the previous analysis result for the read event information (No in step S51), collator 21 does not output the previous analysis result for the event information.

For example, collator 21 may obtain only the raw data among the raw data and the determination result, collate the obtained raw data with each of one or more items of previously obtained raw data, and determine whether the one or more items of previously obtained raw data include raw data similar to the obtained raw data. When such raw data is available, authority determiner 24 may determine whether the user is authorized to view the analysis result for the raw data. When the user is authorized to view the analysis result, collator 21 may output the previous analysis result for the similar raw data.

An example of the operation of analysis support device 20a has been described above.

The analysis support method according to Embodiment 2, includes: collating the raw data obtained with each of the one or more items of previously obtained raw data (step S3); determining whether the one or more items of previously obtained raw data include similar raw data that is similar to the raw data obtained (step S4); when the one or more items of previously obtained raw data include the similar raw data (Yes in step S4), determining whether a user is authorized to view a previous analysis result for the similar raw data (step S51); and when the user is authorized to view the previous analysis result for the similar raw data, outputting the previous analysis result for the similar raw data (step S5).

With this, when the user is authorized to view the analysis result for the raw data, it is possible to output the analysis result for the raw data. This prevents unauthorized persons from viewing the analysis result.

Whether authorization required for viewing is given and types of the authorization may be set individually for each of the one or more items of previously obtained event information.

### OTHER EMBODIMENTS

The analysis support method and the like according to the present disclosure has been described based on the embodiments. However, the present disclosure is not limited to the embodiments. A form obtained by making various modifications conceivable by those skilled in the art to the embodiments without departing from the gist of the present disclosure may also be included in the present disclosure.

For example, display 23 may preferentially display the previous analysis result with a large number of “likes” from people.

Moreover, for example, with a decrease in the number of items of event information stored in the database, the predetermined threshold value may decrease.

Moreover, for example, raw data collation may be performed by clustering determinations using artificial intelligence.

Moreover, it may be that one or more entries to be used for collation can be selected arbitrarily from among a plurality of entries included in the raw data.

Each of the structural elements in the above-described embodiments may be configured in the form of an exclusive hardware product, or may be realized by executing a software program suitable for the structural element. Each of the structural elements may be realized by means of a program executing unit, such as a CPU or a processor, reading and executing the software program recorded on a recording medium such as a hard disk or a semiconductor memory. Here, the software program for realizing the analysis support method according to each embodiment is a computer program that causes a computer to execute each step in the flowcharts in FIG. 2, FIG. 5, FIG. 6, FIG. 8, FIG. 10, FIG. 11, and FIG. 15.

The following cases are also included in the present disclosure.
(1) At least one device descried above is specifically a computer system including a microprocessor, a read only memory (ROM), a random access memory (RAM), a hard disk unit, a display unit, a keyboard, a mouse and the like. The RAM or the hard disk unit stores a computer program. The at least one device achieves its function by the microprocessor operating according to the computer program. Here, a computer program is formed of combinations of instruction codes indicating commands to a computer to achieve a predetermined function.
(2) Part or all of the structural elements included in the at least one device may be configured by a single system large scale integration (LSI). The system LSI is an ultra-multifunctional LSI manufactured by integrating a plurality of structural elements on a single chip, and specifically, is a computer system including a microprocessor, a ROM, a RAM and the like. A computer program is stored in the RAM. The system LSI achieves its function by the microprocessor operating according to the computer program.
(3) Part or all of the structural elements included in the at least one device may be configured with an integrated circuit (IC) card removable from each device or a single module. The IC card or the module is a computer system including a microprocessor, a ROM, a RAM, and the like. The IC card or the module may include the above-mentioned ultra-multifunctional LSI. The IC card or the module achieves its function by the microprocessor operating according to the computer program. The IC card or the module may be tamper resistant.
(4) The present disclosure may be implemented by the method described above. Moreover, the method may be a computer program implemented by a computer or a digital signal configured from the computer program.

Moreover, the present disclosure may be a computer program or a digital signal recorded on a computer-readable recording medium, such as a flexible disk, a hard disk, a compact disc (CD)-ROM, a DVD, a DVD-ROM, a DVD-RAM, a BD (Blu-ray (registered trademark) Disc), and a semiconductor memory. Moreover, it may be the digital signal recorded on these recording media.

Moreover, the present disclosure may transmit the computer program or digital signal via an electronic communication line, a wireless or wired communication line, a network represented by the Internet, a data broadcast, and the like.

Moreover, the program or the digital signal may be recorded on a recording medium and transferred, or the program or the digital signal may be transferred via the network or the like to be implemented by another independent computer system.

While various embodiments have been described herein above, it is to be appreciated that various changes in form and detail may be made without departing from the spirit and scope of the present disclosure as presently or hereafter claimed.

### Further Information about Technical Background to this Application

The disclosures of the following patent applications including specification, drawings, and claims are incorporated herein by reference in their entirety: Japanese Patent Application No. 2021-203570 filed on Dec. 15, 2021, and PCT International Application No. PCT/JP2022/030663 filed on Aug. 10, 2022.

### INDUSTRIAL APPLICABILITY

The analysis support method, and the like according to the present disclosure is applicable to a method and the like that supports analysis of an event in a monitored object.

1. An analysis support method performed by an analysis support device that supports an analysis of an attack scenario in an event that has occurred in a monitored object, the analysis being performed based on raw data related to the event, the analysis support method comprising:
obtaining the raw data by communicating with the monitored object or communicating with a database that stores the raw data obtained from the monitored object; and
outputting a previous analysis result for previously obtained raw data that is similar to the raw data obtained.

2. An analysis support method performed by an analysis support device that supports an analysis of an attack scenario in an event that has occurred in a monitored object, the analysis being performed based on raw data related to the event, the analysis support method comprising:
obtaining the raw data and a determination result that is obtained by a security information and event management device based on the raw data; and
outputting a previous analysis result for previously obtained raw data and a previously obtained determination result that are similar to the raw data obtained and the determination result obtained.

3. The analysis support method according to claim 1, comprising:
collating the raw data obtained with each of one or more items of previously obtained raw data;
determining whether the one or more items of previously obtained raw data include similar raw data that is similar to the raw data obtained; and
when the one or more items of previously obtained raw data include the similar raw data, outputting a previous analysis result for the similar raw data.

4. The analysis support method according to claim 3,
wherein the raw data includes a plurality of entries, and
the analysis support method comprises:
collating a content of each of the plurality of entries included in the raw data obtained with a content of each of a plurality of entries included in each of the one or more items of previously obtained raw data; and
when the one or more items of previously obtained raw data include raw data that includes a plurality of entries that are identical in content to the plurality of entries included in the raw data obtained, determining that the one or more items of previously obtained raw data include the similar raw data.

5. The analysis support method according to claim 3,
wherein the raw data includes a plurality of entries, and
the analysis support method comprises:
collating a content of each of the plurality of entries included in the raw data obtained with a content of each of the plurality of entries included in each of the one or more items of previously obtained raw data;
calculating a score for each of the one or more items of previously obtained raw data, by (i) adding a point when the content of each of the plurality of entries included in the raw data obtained is identical to a content of a corresponding one of the plurality of entries included in each of the one or more items of previously obtained raw data, and (ii) adding no point or deducting a point when the content of each of the plurality of entries included in the raw data obtained is not identical to the content of the corresponding one of the plurality of entries included in each of the one or more items of previously obtained raw data; and
when the one or more items of previously obtained raw data include raw data with a calculated score that is greater than or equal to a predetermined threshold value, determining that the one or more items of previously obtained raw data include the similar raw data.

6. The analysis support method according to claim 1,
wherein the raw data includes a plurality of entries,
the one or more items of previously obtained raw data are classified into one or more groups according to each of the plurality of entries, and
the analysis support method comprises:
when the one or more groups include a group related to a content identical to a content of each of the plurality of entries included in the raw data obtained, classifying the raw data obtained into the group; and
when the one or more groups include no group related to the content identical to the content of each of the plurality of entries included in the raw data obtained, classifying the raw data obtained into a new group.

7. The analysis support method according to claim 6, comprising:
collating the content of each of the plurality of entries included in the raw data obtained with a content of each of the plurality of entries related to each of the one or more groups; and
when the one or more groups include a group related to a content identical to the content of each of the plurality of entries included in the raw data obtained, determining that the one or more items of previously obtained raw data include raw data similar to the raw data obtained.

8. The analysis support method according to claim 6, comprising:
collating the content of each of the plurality of entries included in the raw data obtained with a content of each of the plurality of entries related to each of the one or more groups;
calculating a score for each of the one or more groups, by (i) adding a point when the content of each of the plurality of entries included in the raw data obtained is identical to a content of a corresponding one of the plurality of entries related to each of the one or more groups, and (ii) adding no point or deducting a point when the content of each of the plurality of entries included in the raw data obtained is not identical to the content of the corresponding one of the plurality of entries related to each of the one or more groups; and
when the one or more groups include a group with a calculated score that is greater than or equal to a predetermined threshold value, determining that the one or more items of previously obtained raw data include raw data similar to the raw data obtained.

9. The analysis support method according to claim 1, comprising:
collating the raw data obtained with each of the one or more items of previously obtained raw data;
determining whether the one or more items of previously obtained raw data include similar raw data that is similar to the raw data obtained;
when the one or more items of previously obtained raw data include the similar raw data, determining whether a user is authorized to view a previous analysis result for the similar raw data; and
when the user is authorized to view the previous analysis result for the raw data, outputting the previous analysis result for the similar raw data.

10. An analysis support device that supports an analysis of an attack scenario in an event that has occurred in a monitored object, the analysis being performed based on raw data related to the event, the analysis support device comprising:
a processor; and
a memory connected to the processor,
wherein the processor executes, using the memory:
obtaining the raw data by communicating with the monitored object or communicating with a database that stores the raw data obtained from the monitored object; and
outputting a previous analysis result for previously obtained raw data that is similar to the raw data obtained.
